(19) United States
(12) Patent Application Publication
(10) Pub. No.: US 2026/0203771 A1
(43) Pub. Date: Jul. 16, 2026

(54) METHOD AND SYSTEM FOR ANALYZING SUBSCRIBER DEVICE COMMUNICATION ISSUES BASED ON A COMBINATION OF CUSTOMER DEVICE AND NETWORK NUMERIC DATA AND CUSTOMER CARE CALL LANGUAGE DATA USING GRAPH MODELING

(71) Applicant: T-Mobile Innovations LLC, Overland Park, KS (US)

(72) Inventor: Do Kyu LEE, Mercer Island, WA (US)

(21) Appl. No.: 19/022,853

(22) Filed: Jan. 15, 2025

(51) Int. Cl. G06Q 30/016; H04M 1/72403; H04M 3/42; H04M 3/51

(52) U.S. Cl. CPC G06Q 30/016; H04M 3/42221; H04M 3/5175; H04M 1/72403

(57) ABSTRACT

A method of performing joint analysis of customer device and network numeric data and customer care call language data using graph data modeling, the method comprising receiving live language data associated with a live customer care call from a particular subscriber device, wherein the live language data comprises an indication of a communication issue associated with the particular subscriber device; receiving live numeric data associated with communications of the particular subscriber device; analyzing the live language data, the live numeric data, historical language data associated with customer care calls from a first plurality of subscriber devices, historical numeric data associated with communications of a second plurality of subscriber devices to generate a graph database and identify a candidate cause associated with the communication issue of the particular subscriber device; and initiating, based on the identified candidate cause, an action at the particular subscriber device.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A telecommunication service provider may provide various communications services (e.g., voice, text, and/or data) to customers. Customer care refers to the support and assistance provided by a telecommunication service provider to its customers. Customer care may include interactions from initial service setup, ongoing support with billing issues, troubleshooting technical problems, and addressing any inquiries that its customers may have, aiming to increase customer satisfaction and reduce churn rate. For example, a customer experiencing an issue (e.g., drop calls, poor audio quality, slow Internet connection, etc.) with a service provided by a service provider may call the customer care of the provider to troubleshoot the issue. In some cases, the service provider may use automatic troubleshooting systems which leverage machine learning (ML)-based solutions to assist customer care agents in identifying the root cause of a customer service issue and responding to the user. If the issue cannot be resolved over the phone, the customer care agent may create a ticket documenting the issue and/or any attempt in resolving the issue and forward the ticket to an expert team for offline analysis and resolution.

### SUMMARY

In an embodiment, a computer-implemented method of analyzing subscriber device communication issues based on a joint analysis of customer device and network numeric data and customer care call language data using graph data modeling is disclosed. The method comprises receiving, by an application at a computer system, live language data associated with a live customer care call from a particular subscriber device, wherein the live language data comprises an indication of a communication issue associated with the particular subscriber device; receiving, by the application, live numeric data associated with communications of the particular subscriber device; analyzing, by the application, the live language data, the live numeric data, historical language data associated with customer care calls from a first plurality of subscriber devices, historical numeric data associated with communications of a second plurality of subscriber devices to identify a candidate cause associated with the communication issue of the particular subscriber device, wherein the analyzing comprises generating a graph database based on a data portion from each of the live language data, the live numeric data, the historical language data, and the historical numeric data, wherein the candidate cause is identified based on the graph database; and initiating, based on the identified candidate cause, an action at the particular subscriber device.

In another embodiment, a computer-implemented method of analyzing subscriber device communication issues is disclosed. The method comprises receiving, by an application at a computer system, live language data associated with a live customer care call from a particular subscriber device, wherein the live language data is indicative of a communication issue associated with the particular subscriber device; receiving, by the application, live numeric data associated with communications of the particular subscriber device; analyzing, by the application, the live language data, the live numeric data, historical language data associated with customer care calls from a first plurality of subscriber devices, historical numeric data associated with communications of a second plurality of subscriber devices, using a graph database generation model, wherein the analyzing comprises selecting first data portions, each from a respective one of the live language data, the live numeric data, the historical language data, and the historical numeric data; determining, based on the selected first data portions, a plurality of first attributes; generating, based on the plurality of first attributes, a first graph database; updating the graph database generation model, based on at least one of feedback on the first graph database or a target objective, to generate a second graph database; determining, by the application, a candidate cause associated with the communication issue based on the second graph database; and providing, by the application, via a user interface (UI), a visual representation of the second graph database and a visual indication of the candidate cause.

In yet another embodiment, a method comprising receiving, by an application at a computer system, live language data associated with a live customer care call from a particular subscriber device reporting a communication issue associated with the particular subscriber device; receiving, by the application, live numeric data associated with communications of the particular subscriber device; retrieving, by the application, from a first relational database, historical language data associated with customer care calls from respective ones of a first plurality of subscriber devices; retrieving, by the application, from a second relational database, historical numerical data associated with communications of a second plurality of subscriber devices; analyzing, by the application, the live language data, the live numeric data, the historical language data, and the historical numeric data to identify a candidate cause associated with the communication issue of the particular subscriber device, wherein the analyzing comprises determining a plurality of attributes based on a first portion of the live language data, a second portion of the live numeric data, a third portion of the historical language data, and a fourth portion of the historical numeric data; and generating, based on the plurality of attributes, a graph database comprising nodes connected by edges, wherein each of the nodes corresponds to a respective one of the plurality of attributes, and wherein the candidate cause is identified based on connections among a subset of the nodes in the graph database; and outputting, by the application, based on the candidate cause, a recommended response to the live customer care call.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system according to an embodiment of the disclosure.

FIG. 2 is a sequence diagram illustrating a method of analyzing subscriber device communication issues based on a combination of customer device and network numeric data and customer care call language data using graph modeling according to an embodiment of the disclosure.

FIG. 3 illustrates a visual representation of an example graph database according to an embodiment of the disclosure.

FIG. 4 is a flow chart of a method according to an embodiment of the disclosure.

FIG. 5 is a flow chart of another method according to an embodiment of the disclosure.

FIG. 6A and FIG. 6B are block diagrams of a fifth generation (5G) network according to an embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In certain examples, when a customer or subscriber calls a customer care service to complain or report a certain technical communication issue (e.g., drop calls, poor audio quality, slow Internet connection, etc.), the subscriber may navigate through an interactive voice recognition (IVR) system (e.g., a computer system) before getting to a customer care agent. Along the way, the IVR system may capture the audio of the subscriber and convert the captured audio to a format (e.g., text data) that can be automatically analyzed. For instance, a customer care system (e.g., a computer system) may receive the text data and apply tokenization, annotation, and vectorization to the text data to create language data for machine learning (ML) processing. Tokenization is the process of partitioning a text into smaller units called tokens (e.g., words, characters, or sub-words, etc.). Annotation is the process of labelling data with metadata or tags to provide additional context. The labelling can include sentiment information for sentiment analysis (e.g., opinions or emotions), named entities for named entity recognition (e.g., key information extraction), syntax for speech analysis (e.g., breaking down sentences to grammatical components to understand the sentence structure and its meaning), etc. Vectorization is the process of converting text data to embeddings (encoded numeric values) suitable for ingestion by ML model(s). In some cases, the customer care system may continue to record the call interactions between the subscriber and the customer care agent during the call and apply tokenization, annotation, and vectorization to the recorded audio data to create further language data.

The customer care system may utilize a ML model to guide the customer care agent in responding to the subscriber or root-causing the issue of the subscriber. The ML model may be trained on a large set of data including past customer or subscriber reported issues and corresponding responses, root causes, solutions, and/or corrective actions for the issues. For instance, the language data generated from the captured audio may be provided as an input to the ML model. The ML model may process the language data to predict a potential response, root cause, solution, and/or corrective action for the issue. The customer care agent may leverage the output of the ML model in assisting the subscriber to provide an answer to the subscriber and/or resolve the issue of the subscriber. In some instances, the customer care agent may also request the subscriber to perform certain tests on the subscriber's user equipment (UE) and/or check certain UE settings to assist in the troubleshooting.

In some cases, the technical issues reported by subscribers may be complex and may require offline analysis (e.g., by technical experts and/or data scientists with domain knowledge). The offline analysis may be based on data collected by the service provider. For instance, the service provider may collect a variety of network data for diagnostic purposes and proactive issue identification to maintain service quality and prevent disruptions. The collected network data may span multiple layers of a communication service stack. For example, collected network data may include network performance metrics (e.g., receive signal strength indicators (RSSIs), reference signal received powers (RSRPs), reference signal receive quality (RSRQs), signal-to-interference-plus-noise ratios (SINRs), latencies, bandwidth utilizations, bit error rates (BERs), packet error rates (PERs), throughputs, etc.), alarms (e.g., errors or issues detected in the network), and logs (e.g., timestamped records of network or signaling events), quality of service (QOS) indicators (e.g., call quality metrics, streaming quality, service availability, etc.), and location data (e.g., user locations and handover or mobility patterns, etc.).

As an example, a subscriber may call customer care to complain about an audio quality issue (e.g., a call drop). However, the audio quality issue or call drop issue may be unrelated to the subscriber's device, transmit audio, or radio frequency (RF) signal transmissions and/or receptions. Instead, the issue may be caused by a transcoding incompatibility between the network of the caller and the network of the callee. For instance, the subscriber (e.g., the caller) may be in a network coverage area (e.g., a 3rd Generation Partnership Project (3GPP) fourth-generation (4G) or fifth generation (5G) network coverage area) that uses enhanced voice service (EVS) audio codec while the other party (e.g., the receiving subscriber device or the callee) may be in a network coverage area (e.g., second-generation (2G) or third-generation (3G)) where EVS audio codec is unsupported. To track down and root cause the audio quality issue to be due to the transcoding incompatibility, a technical expert and/or data scientist may analyze the network data collected by the service provider. For instance, a technical expert may analyze timestamped network and/or signaling events associated with the subscriber who made the complaint, location data of the caller and the callee, and/or cell towers that served the caller and the callee).

The collected network data may be typically stored in relational databases (e.g., column-row tables with various measurements, metrics, and events in columns and voice calls or data sessions in rows, or vice versa). The amount of data can be large, and the analysis may require various specific custom codes (e.g., codes written specifically for analyzing certain key performance indicators (KPIs) to determine the cause) to be run on the collected data. For instance, to track down the audio quality issue, specific codes may be written to repeatedly query and/or search for data related to (or indicative of) a KPI for audio quality in the relational databases. Writing specific or custom codes for each specific KPI analysis may be resource-intensive. The processing of those specific or custom codes can also be processing-intensive. Further, the analysis can be time-consuming. Thus, while a telecommunications service provider may utilize ML processing on recorded customer care calls to guide customer care agents in assisting subscribers with their technical issues and subsequent offline analysis by domain experts to diagnose and root-cause complex technical issues, such an approach can be inefficient and costly. Accordingly, there is a need to improve the process for telecommunications technical issues troubleshooting. While ML models and large-language models (LLMs) are being explored to assist operations in various industries, there is currently no general foundation model available for analyzing telecommunication service-related language data and numeric data (e.g., the network data) in a combined or joint manner to quickly troubleshoot technical telecommunication issues.

The present disclosure provides a technical solution to the aforementioned technical problems in the technical field of data pattern analysis for analyzing and troubleshooting telecommunication issues. More specifically, the present disclosure provides an efficient data analysis system (e.g., a computer system) that optimizes the telecommunication issues troubleshooting process by utilizing a combination of two different types of information to conduct joint analysis. One type of information is objective and/or numerical information (e.g., subscriber device identification information, performance metrics, serving cell information, location information, signaling data and/or events, call information, device user interface (UI) information, network events, etc.) collected from a telecommunications network and/or associated subscriber devices. The other type of information is language information (e.g., non-objective and non-numerical origin) collected from customer care calls (e.g., recorded, transcribed, tokenized, annotated, and vectorized as discussed above). The numeric data and the language data are stored in relational databases. The system utilizes a foundation model (e.g., a multimodal learning (MML) model) to generate a graph database from the numeric data and language data relational databases.

A graph database may represent data by nodes and edges. Edges may correspond to relationships. Since a graph database is not restricted to a pre-defined data model, a graph database may provide a flexible platform for finding relationships among complex, large data. For instance, a graph database may be generated in runtime, based on a subscriber device communication issue reported by a subscriber, to include nodes corresponding to phone numbers of calling and receiving subscriber devices, nodes corresponding to geographical locations, nodes corresponding to a certain signaling pattern (e.g., a session initiation protocol (SIP) signaling pattern), nodes corresponding to geographical locations, nodes corresponding to certain KPIs (e.g., drop calls, signal qualities, throughputs, latencies, etc.), and/or nodes corresponding to other measurements and/or events. The relationships or connections among the nodes may provide insights to what may be related to or caused the reported issue.

In an example, the system may present the graph database in a visual representation to enable a quick visualization of relations among various data (e.g., potential causes and results). The visual representation may enable a customer care agent to quickly determine a possible cause of a subscriber's communication issue (e.g., an insight to a cause related to the issue) based on the relations or connections (e.g., a data pattern) shown in the graph database and explain the status of the issue to the subscriber. That is, instead of generating and utilizing specific custom codes to analyze and troubleshoot a telecommunication issue, a graph database is generated in runtime to provide a quick visualization or indication of a possible cause for the issue based on the connections among the nodes. The graph modeling approach not only avoids the need for specific custom codes for the analysis but also enables a customer care agent to quickly respond to a subscriber over the phone that would otherwise require offline analysis by domain experts, thereby greatly improving troubleshooting efficiency, cost, and customer satisfaction.

Referring to the above audio quality issue example, the graph database may show a cluster of nodes corresponding to subscriber devices in a 4G or 5G coverage area in calls with another cluster of nodes corresponding to subscriber devices in a 2G or 3G coverage area, and they are all connected to nodes corresponding to low audio quality (e.g., low mean opinion score (MOS) indicating low QoS) or drop audio packets and nodes corresponding to high signal quality (e.g., high RSRPs, high RSRQs, high SINRs). Because all those calls have high signal quality but low audio quality (e.g., indicated by the cluster of nodes with various low MOS QoS), the customer care agent may determine that RF signal transmissions/receptions may not be the issue. The customer care agent may track the issue down to be related to the two different network coverage areas (e.g., the incompatible transcoding algorithms used in the 4G or 5G area and 2G or 3G area). In some examples, the system may automatically initiate an action based on a possible cause determined, from the graph database, for a communication issue of a subscriber device. For instance, the system may initiate (e.g., over the air) an installation of a software patch (e.g., for security updates, bug fixes, feature updates, software upgrades, etc.) to a subscriber device, a configuration update (e.g., a network setting, a preferred roaming list, a device profile, etc.) at the subscriber device, or reboot at the subscriber device.

According to an embodiment of the present disclosure, a telecommunications network may include the data analysis system. The data analysis system may include a data analysis application (e.g., software) that analyzes a combination of customer care call language data and customer device and network numeric data and using a graph model to identify possible or candidate cause(s) of technical issues reported by subscribers. For instance, the data analysis application may receive live language data generated from a live customer care call where a subscriber complains about a communication issue experienced by a device (e.g., a particular subscriber device) of the subscriber. The live language data may be received in real time or near real time. The data analysis application may also receive live numeric data collected from communications associated with the particular subscriber device in real time or near real time. To facilitate the analysis and/or troubleshooting of the communication issue of the particular subscriber device, the data analysis application may retrieve, from a customer care call interaction database (e.g., a first database), historical language data generated from customer care calls associated with respective ones of a first group of subscriber devices. The data analysis application may further retrieve, from a customer device and network data database (e.g., a second database), historical numeric data collected from communications associated with a second group of subscribers, which may be the same or different than the first group of subscribers.

The live language data may be generated in real time from audio recorded from the live customer care call (from the individual subscriber), utilizing speech-to-text conversions, tokenization, annotation, and vectorization applied to the recorded audio data. The historical language data may be generated in a similar way but from past customer care calls from the first group of subscribers. The live numeric data may include operational data captured from radio layer operations, modem layer operations, application layer operations, signaling layer operations, and/or OS operations at the particular subscriber device (during the live customer care call). The historical numeric data may include substantially similar operational data and may be collected from the second group of subscriber devices and/or from the network. Generally, operational data captured from a subscriber device may be referred to as device operational data (or device data), and operational data captured from the network may be referred to as network operational data (or network data). Examples of numeric device and/or network operational data may include, but are not limited to, performance metrics (e.g., RSSIs, RSRPs, RSRQs, SINRs, BERs, PERs, latencies, throughputs, audio packet qualities, etc.), serving cell information (e.g., cell identifier (ID), carrier frequency, carrier band configuration, etc.), location information (e.g., subscriber device location data, mobility patterns, etc.), signaling data and/or events (e.g., a time series of SIP signaling events or signaling patterns), call information, device UI information, network events, etc. In an example, a SIP message can include a text message in the SIP message body and can be associated with RF information when the SIP message is delivered. That is, a SIP INVITE, UPDATE, 180 RINGING, and/or BYE message can be transmitted with RF information. In an example, a SIP message itself is a character string, and vectorization can be applied to the message and aggregated with the non-numeric data. In some examples, at the beginning of a customer care call, a subscriber may be asked whether they consent to the recording of their call to the customer care and/or capturing of their subscriber device data (e.g., over the air (OTA)) for analysis. In some examples, a subscriber may be asked to sign an agreement to consent to the capturing of their subscriber device data on an on-going basis for historical data analysis. Thus, in some cases, the historical numeric data may also include numeric data captured from the particular subscriber device over a past time period.

The data analysis application may analyze the live language data associated with the particular subscriber device, the live numeric data associated with the particular subscriber device, the historical language data associated with the first group of subscriber devices, and the historical numeric data associated with the second group of subscriber devices, using graph modeling, to identify a candidate cause associated with the communication issue of the particular subscriber device. As part of the analysis, the data analysis application may select a relevant data portion from each of the live language data, the live numeric data, the historical language data, and the historical numeric data. For instance, the data analysis application may select, based on the communication issue of the particular subscriber device, a first portion from the live language data, a second portion from the live numeric data, a third portion from the historical language data, and a fourth portion from the historical numeric data. Since the live language data, the live numeric data, the historical language data, and the historical numeric data may include a large amount of information, selecting relevant portions (e.g., with high priorities for the communication issue) can speed up the analysis and provide a more focused analysis for the communication issue of the particular subscriber device. As an example, language data can include not only information describing the communication issue and/or sentiments of a subscriber who made a customer care call but also other irrelevant information (e.g., general conversations between a customer care agent and the subscriber). In a similar way, numeric data can include data and/or events captured from various layers of a communication service stack (e.g., radio layer, modem layer, application layer, OS layer, etc.). Depending on the reported issue, not all captured data may be relevant.

The live language data, the live numeric data, the historical language data, and the historical numeric data may be stored in relational databases (e.g., tables with columns and rows). For instance, a numeric data relational database may store various measurements, metrics, and events in columns, and each row may correspond to a communication session (e.g., voice calls or data sessions) or a particular time within a communication session, or vice versa. In a similar way, a language data relational database may store words, sentences, annotations, etc. in columns, and each row may correspond to a customer care call or a portion of a customer care call, or vice versa. Thus, in some instances, the selection of each of the first portion, the second portion, the third portion, and the fourth portion may correspond to selecting one or more high-priority columns (or rows) from respective ones of the relational databases. For instance, the data analysis application may prioritize the columns (or rows) in the relational databases based on the communication issue and selects a subset of the columns (or rows) with the highest priorities.

Next, the data analysis application may generate attributes based on the selected first portion of the live language data, the second portion of the live numeric data, the third portion of the historical language data, and the fourth portion of the historical numeric data. The attributes may be related to performance metrics, serving cell information, location information, signaling information (e.g., signaling patterns, data, and/or events), call information, device UI information, network events, etc. As an example, the data analysis application may generate four attributes, A1-A4, each from a respective column of a respective relational database. Referring to the audio quality or call drop issue example above, the attribute A1 may correspond to audio packet quality, the attribute A2 may correspond to a SIP signaling pattern, the attribute A3 may correspond to handover events associated with receiving subscriber devices, and the attribute A4 may correspond to specific location or specific timing of calls. In some instances, the data analysis application may utilize an ML model (e.g., a regression model, such as a support vector machine (SVM) model) for the data portion selection and the attribute generation.

After determining the attributes, the data analysis application may generate a graph database based on the attributes and corresponding data. The graph database may include nodes corresponding to the attributes. Referring to the examples with attributes A1-A4, the graph database may include a first subset of the nodes corresponding to attribute A1, a second subset of the nodes corresponding to attribute A2, a third subset of the nodes corresponding to attribute A3, and a fourth subset of the nodes corresponding to attribute A4. The nodes may be connected based on respective data in the relational databases. As an example, the first data portion may include column W of the live language data, the second data portion may include column X of the live numeric data, the third data portion may include column Y of the historical language data, and the fourth data portion may include column Z of the historical numeric data. A set of connected nodes may include a first node corresponding to attribute A1, a second node corresponding to attribute A2, a third node corresponding to attribute A3, and a fourth node corresponding to attribute A4, where the first, second, third, and fourth nodes may respectively include first data in column W and row R1 of the live language data, second data in column X and row R2 of the live numeric data, third data in column Y and row R3 of the historical language data, and fourth data in in column Z and row R4 of the historical numeric data.

The data analysis application may identify or indicate a candidate cause for the communication issue of the particular subscriber device based on relations among the nodes in the graph database. In an embodiment, the data analysis application may generate a visual representation of the graph database and provide the visual representation of the graph database via a UI of the telecommunications data analysis system. In an embodiment, a customer care agent may examine the visual representation of the graph database to identify the candidate cause and provide a response to the subscriber who made the customer care call based on the identified candidate cause. In some embodiments, the data analysis application may provide a recommended response to the live customer care call based on the identified candidate cause. In some embodiments, the data analysis application may initiate an action to resolve the communication issue of the particular subscriber device based on the identified candidate cause. In some embodiments, the data analysis application may automatically initiate an update (e.g., a software update or a configuration update) or a power-cycle at the particular subscriber device based on the identified candidate cause.

In some embodiments, the data analysis application may dynamically update (or optimize) the graph database generation based on a target objective and/or feedback. In an example, the target objective may be based on a proximal policy optimization (PPO) algorithm. For the audio quality issue example, the target objective may be associated with RF values (e.g., RSRPs, RSRQs, SINRs, etc.) or QoS (e.g., MOS score). In some examples, the PPO may be associated with SIP messages and associated with RF values or attributes. In an example, the feedback may be human feedback (e.g., from the customer care agent) based on a failure to identify a correlation or relation among the nodes in an initial graph database or a new insight observed from the initial graph database. As part of the dynamic update, the data analysis application may reselect, based on the target objective and/or the feedback, a fifth portion from the live language data, a sixth portion from the live numeric data, a seventh portion from the historical language data, and an eighth portion from the historical numeric data. Generally, one or more of the fifth, sixth, seventh, and eighth data portions may be different than the respective first, second, third, and fourth data portions.

The data analysis application may determine second attributes based on the reselected fifth, sixth, seventh, and eighth data portions. The data analysis application may generate a second graph database based on the second attributes. The updated graph database (e.g., second graph database) may include nodes corresponding to the second attributes, and the nodes may be connected by connections based on corresponding data (in the fifth, sixth, seventh, and eighth data portions). As an example, the initial attributes for generating the initial graph database may be A1-A4, and the second attributes for generating the updated graph database may be A1-A3. As another example, the initial attributes for generating the initial graph database may be A1-A4, and the second attributes for generating the updated graph database may be A1-A3 and A5. Generally, the second attributes may include at least one different attribute than the initial attributes and/or exclude at least one of the initial attributes. In some instances, the dynamic update (e.g., the data selection, the attribute generation, and the graph database generation) may iterate through multiple iterations until the target objective is satisfied or when the customer care agent can successfully identify a candidate cause for the communication issue of the particular subscriber device. In some instances, the dynamic update may occur while the live customer care call is in progress.

In some embodiments, the data analysis application may utilize a multimodal learning (MML) model for the graph modeling to generate graph database(s) from the live language data, the live numeric data, the historical language data, and the historical numeric data. For instance, the MML model may process the live language data, the live numeric data, the historical language data, and the historical numeric data to generate a graph database. In some embodiments, the data analysis application may utilize a dimensional model (e.g., a medallion model) for the graph modeling. The medallion model organizes and processes data in distinct, hierarchical layers. The hierarchical layers may include a bronze layer, a silver layer, and a gold layer representing different stages of data refinement, with each layer progressively transforming raw data into highly refined, analytics-ready datasets. For instance, the bronze layer may include the live language data, the live numeric data, the historical language data, and the historical numeric data as raw data. The silver layer may include selecting data portions from the live language data, the live numeric data, the historical language data, and the historical numeric data and generating attributes from the selected data portions. The gold layer may include generating a graph database based on the selected data portions and generated attributes.

In some embodiments, the data analysis application may share a generated graph database (e.g., the visual representation of the graph database) with other customer care agents who may be serving customers experiencing a similar communication issue as the particular subscriber device. For instance, the data analysis application may share the visual representation of the graph database via a web link, and the other customer care agents may access the link (e.g., via certain permissions, such as login name and password, etc.) to view the graph database. In some instances, as the graph database generation model is dynamically updated, updated graph databases may be uploaded to the web location identified by the web link. The shared graph database(s) may assist the other customer care agents in assisting their customers.

Utilizing a combination of customer device and network numeric data and customer call language data for joint analysis can provide a more complete view of an issue experienced by a subscriber device and/or a corresponding possible cause. Referring to the audio quality issue example, the subscriber may call customer care about dropped calls or low audio quality. However, the cause is unrelated to the subscriber device and is instead due to the other party being in an area with an incompatible audio codec. Analyzing the customer care call language data alone may not lead to the finding of the incompatible audio codec. Utilizing a combination of real-time language and numeric data and historical language and numeric data for joint analysis can provide further data points for the analysis. As an example, a subscriber may call customer care about an intermittent issue that may not occur at the time of the call, but the issue may be captured by the historical data. As another example, a subscriber may call customer care about an issue, which may be a common issue among subscribers in a certain area (e.g., due to a cell outage) captured in the historical data.

Utilizing a graph database to jointly analyze customer care call language data and customer device and network numeric data can provide a flexible way of finding relationships across the customer care call language data and customer device and network numeric data. For instance, data portions relevant to a customer reported issue can be quickly selected and a graph database and a corresponding visual presentation of the graph database can be quickly generated (e.g., in a couple of mins to 10 mins) so that correlation or connections among the data may be explored to identify possible cause(s). Updating the graph database generation model dynamically based on feedback or a target objective can refine the graph database generation model to provide a more desirable result (e.g., closer to finding a possible candidate). Using graph databases for the analysis can eliminate the need for writing specific custom codes (e.g., for each KPI of interest) and/or offline analysis, thereby saving resources, time, and cost. Further, because of the efficiency of the graph modeling-based analysis, a customer care agent may be able to provide a customer with a status of an issue reported by the customer while the customer is on the call, instead of waiting for 1-2 days when the offline analysis is completed, and thus may increase customer satisfaction.

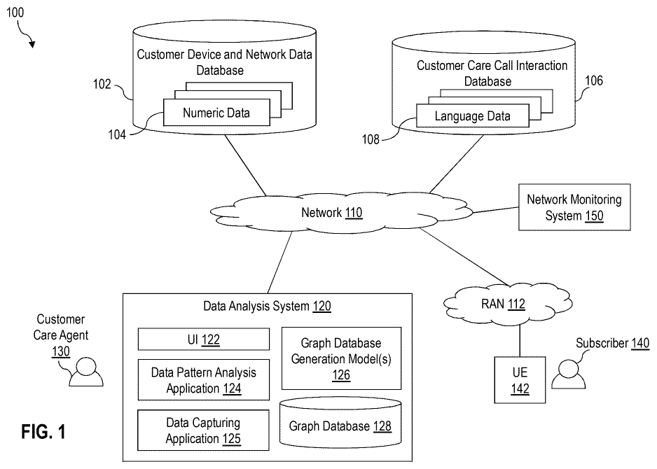

Turning now to FIG. 1, a network system 100 is described. The network system 100 may be a telecommunications service provider network or a mobile service provider network that provides communications services (e.g., voice services, short message services (SMS) services, rich communication service (RCS) services, Internet services, etc.) to subscribers (e.g., the subscriber 140). In an example, the network system 100 may be part of a wireless communication network (e.g., a 3GPP 5G, 4G, 3G, or 2G network). As shown in FIG. 1, the network system 100 includes a customer device and network data database 102, a customer care call interaction database 106, a network 110, a radio access network (RAN) 112, a data analysis system 120, and a network monitoring system 150.

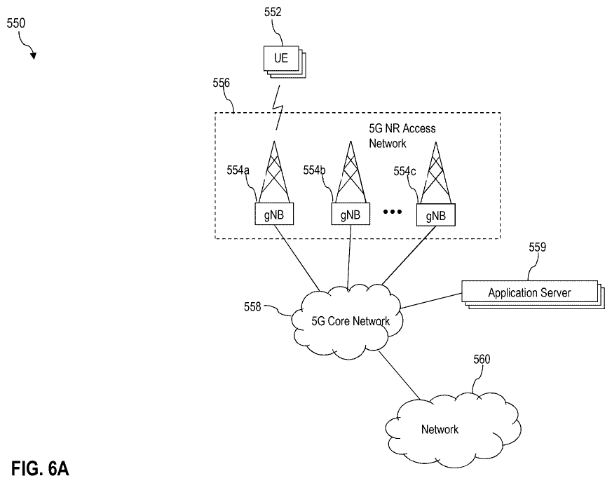

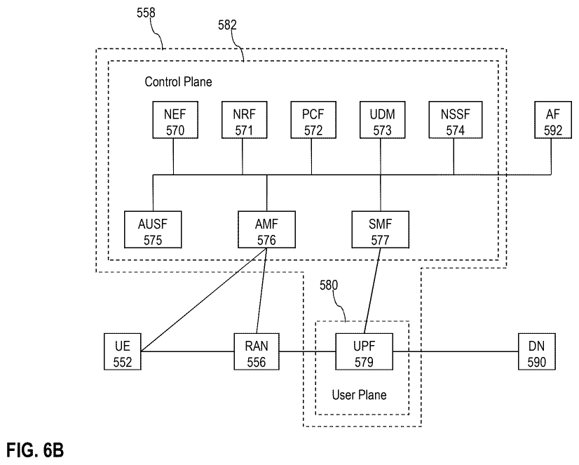

The RAN 112 comprises a plurality of cell sites and backhaul equipment. In an embodiment, the RAN 112 comprises tens of thousands or even hundreds of thousands of cell sites. The cell sites may comprise electronic equipment and radio equipment including antennas. The cell sites may be associated with towers or buildings on which the antennas may be mounted. The cell sites may comprise a cell site router that provides a backhaul link from the cell sites to the network 110. The cell sites may provide wireless links to UE (e.g., the UE 142), for example, according to a 5G, long term evolution (LTE), code division multiple access (CDMA), or a global system for mobile communications (GSM) telecommunication protocol. The network 110 comprises one or more public networks, one or more private networks, or a combination thereof. The RAN 112 may from some points of view be considered to be part of the network 110 but is illustrated separately in FIG. 1 to promote improved description of the system 100. Further, in some examples, the network 110 may include a core network that connects the RAN 112 to other data networks in the network 110. An example of a 5G RAN and 5G core are discussed below with reference to FIGS. 6A and 6B.

The UE 142 may be a cell phone, a mobile phone, a smart phone, a personal digital assistant (PDA), an Internet of things (IoT) device, a wearable computer, a headset computer, a laptop computer, a tablet computer, a notebook computer, embedded wireless modules, and/or other wirelessly equipped communication devices. The subscriber 140 may access communication services (e.g., voice, text, and/or data) provided by the network system 100 via the UE 142. Generally, the network system 100 may serve any suitable number of UEs 142 (e.g., hundreds, thousands, or millions). The terms “UE” and “subscriber device” may be used interchangeably herein, such that a description referring to one of the terms shall be treated as though the description also referred to the other term.

In the context of 3GPP, a UE 142 may perform an initial network attachment to gain access to a core network (e.g., an evolved packet core (EPC) or a 5G core (5GC)). The initial network attachment may include authentication and bearer setup. The bearer may be managed by a radio control layer (RRC) of the RAN 112 and a session management function (SMF) of the core network. To access IMS services (e.g., voice, video, text messaging over Internet protocol (IP) networks), the UE 142 may perform proxy call session control function (P-CSCF) discovery and SIP registration. To establish a communication session, the UE 142 may exchange a sequence of SIP messages with the core network as defined in 3GPP signaling protocols (e.g., including SIP invite, SIP ACK, SIP BYE, SIP cancel, etc.). During a communication session, the core network and the RAN 112 may measure various network performance metrics (e.g., RSSIs, RSRPs, RSRQs, SINRs, latencies, bandwidth utilizations, BERs, PERs, throughput, etc.). The core network and/or the RAN 112 may also monitor for faults and/or alarms and capture various data and/or events for diagnostic and analysis. If the UE 142 moves to different locations during the communication session, the RAN 112 and the core network may handle handovers to ensure session continuity.

The customer device and network data database 102 may include numeric data 104 collected from operations associated with communication sessions of a plurality of subscriber devices (e.g., similar to the UE 142) through the network 110 via the RAN 112. In some instances, the numeric data 104 may include data and/or events associated with radio layer operations, modem layer operations, signaling layer operations, application layer operations, OS layer operations at a UE 142 and/or at the network side (e.g., the RAN 112 and the core network). Examples of radio layer operations may include, but are not limited to, signal transmission and receptions, channel management, power control, link adaptation, carrier aggregation, beamforming, and synchronization. In some instances, performance metrics, such as RSSIs, RSRPs, RSRQs, and SINRs may be computed from radio layer operations. Examples of modem layer operations may include, but are not limited to, signal processing functions, protocol handling, data multiplexing and demultiplexing, network selection, cell selection and handover, and error detection and recovery. In some instances, performance metrics, such as BERs, PERs, latencies, throughputs, serving cell information, and location information may be computed from modem layer operations. Examples of application layer operations may include, but are not limited to, service execution, IMS services, data encryption and decryption, audio encoding and decoding, subscriber phone numbers associated with calls, and user interactions. In some instances, performance metrics, such as audio quality, QoS indicators may be determined from application layer operations. Examples of OS layer operations may include, but are not limited to, resource management, process scheduling, power management, application programming interfaces (APIs) for network and/or hardware access. Examples of signaling layer operations may include, but are not limited to, control plane communications (e.g., IMS signaling, SIP signaling, etc.) between a UE 142 or subscriber device and the network 110. In some instances, signaling patterns may be determined from signaling layer operations.

In some instances, the numeric data 104 may include performance metrics (e.g., RSSIs, RSRPs, RSRQs, SINRs, BERs, PERs, latencies, throughputs, audio packet qualities, etc.), serving cell information (e.g., cell identifier (ID), carrier frequency, carrier band configuration, etc.), location information (e.g., user locations, handover or mobility patterns, etc.), signaling data and/or events (e.g., a time series of SIP signaling events), call information, device UI information (e.g., from the UE 142), network events, and/or any suitable numeric operational data. In some examples, the signaling data and/or events may be based on 3GPP signaling protocols. For instance, the signaling events may include network registration events (e.g., associated with registration, authentication, re-registration), session establishment events (e.g., associated with a SIP invite to establish a session, a call acceptance, an acknowledgement from a UE 142 confirming a session establishment), session termination events (e.g., associated with a SIP bye request to end a session, a SIP cancel request to cancel establishment of a session). In some examples, the signaling data and/or event information may include SIP messages (e.g., SIPLine1, SIPReason, SIP_Origin, etc.) along with RF conditions when this message is detected. RF conditions may include numeric values of Start_RSRP (e.g., initial RSRP), RSRQ, SINR, RSSI, Connected_RSRP (e.g., ongoing RSRP after a connection is established), PS_Handover_RSRSP (e.g., RSRP that determines whether a handover is to be performed), Call_End_RSRP (RSRP at the end of the call), etc.

In some examples, device UI information may include buttons pressed by the subscriber 140 (e.g., to end a call) and/or audio path switch and/or selection (e.g., a headphone, a speaker mode) by the subscriber 140. Examples of call information may include a call duration, a call setup duration, a call drop reason (e.g., a call drop case code number), a call setup failure reason, etc. In some examples, network events may include Initial_Network_Type (e.g., standalone 5G (SA5G), non-standalone (NSA), LTE, evolved-universal terrestrial radio access network (E-UTRAN) New Radio (NR) Dual Connectivity (ENDC), WiFi calling (WFC), 2G/3G, searching, out of coverage), handover to WiFI (HO_to_WIFI), single radio voice call continuity (SRVCC), inter-radio access technology (RAT), intra-RAT, radio resource control status (RRC_STATUS), audio packet loss MOS score, packet loss count measurement_(e.g., at every_5_sec) with RF conditions. Network events may also include timing information, such as Start_time, Invite_Timestamp, Connected_Timestamp, HO_Sucess_Time with RF conditions. Other examples of network events may include HO Start, success, failure with network type, network band, network RRC state reason, with RF conditions. Generally, the numeric data 104 may be collected from the network side of the network system 100 (e.g., by the network monitoring system 150) and/or from the device side (e.g., capturing from the UE 142 and uploading to a server of the network system 100 via OTA). In some instances, a subscriber 140 may be asked to sign an agreement to consent to capturing of their subscriber device data from the UE 142 on an on-going basis for historical data analysis. In some instances, upon the subscriber 140 agreeing to the data capture, an application may be executed on the UE 142 to capture operational data (e.g., numeric data 104) of the UE 142 and upload the captured data back to the network system 100 based on a certain schedule (e.g., every 1-2 days) The customer care call interaction database 106 may include language data 108 generated from customer care calls reporting communication issues experienced by respective ones of a plurality of subscriber devices (e.g., UEs 142). For instance, the telecommunications service provider of the network system 100 may provide customer care to assist customers in troubleshooting various technical issues. When a UE 142 experiences a communication issue (e.g., drop calls, poor audio quality, slow Internet connection, etc.) with the communication services, a user (e.g., the subscriber 140) of the UE 142 may call customer care to make a complaint about the communication issue. To facilitate a customer care agent 130 in troubleshooting customer issues, customer care calls may be recorded (e.g., by an IVR system in the network system 100 and/or the data capturing application 125 at the data analysis system 120). The recorded audio data may be converted to text data. Tokenization, annotation, and vectorization may be applied to the text data to generate the language data 108. In some instances, when a subscriber 140 makes a call to customer care (e.g., via the UE 142), the subscriber 140 may be asked for consent to record the customer care call for analysis.

The network monitoring system 150 is a system implemented by one or more computers. Computers are discussed further hereinafter. The network monitoring system 150 may include software configured to track and analyze various performance metrics (e.g., RSSIs, RSRPs, RSRQs, SINRs, BERs, PERs, latencies, throughputs, serving cell information, etc.), mobility information, and/or signaling messages and/or events (e.g., IMS signaling, SIP signaling, etc.) in the network in the RAN 112 and/or the core network (in the network 110). The network monitoring system 150 may capture and store the operational data as part of the historical numeric data 104 in the customer device and network data database 102.

The data analysis system 120 is a system implemented by one or more computers. Computers are discussed further hereinafter. In some instances, the data analysis system 120 may be part of a customer relationship management (CRM) system of the network system 100. The data analysis system 120 may include at least one memory and at least one processor. The data analysis system 120 may include a data analysis application 124, a data capturing application 125, and graph database generation model(s) 126, each comprising instructions stored in the at least one memory of the data analysis system 120 and executable by the at least one processor of the data analysis system 120.

The data capturing application 125 may capture live audio data upon detecting an incoming customer care call from a subscriber 140 reporting a communication issue (e.g., drop calls, poor audio quality, slow Internet connection, etc.) of a particular subscriber device (e.g., a UE 142) of the subscriber 140. The data capturing application 125 may record the audio of the live customer care call, convert the recorded audio to text data, and apply tokenization, annotation, and vectorization to the text data to generate live language data. The data capturing application 125 may also capture live numeric data associated with communications of the particular subscriber device upon detecting the incoming customer care call. The data capturing application 125 may provide the live language data and the live numeric data to the data analysis application 124 in real time or near real time for analysis.

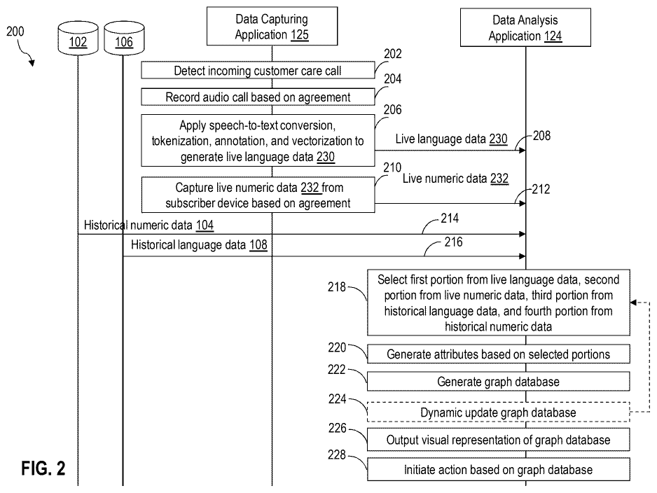

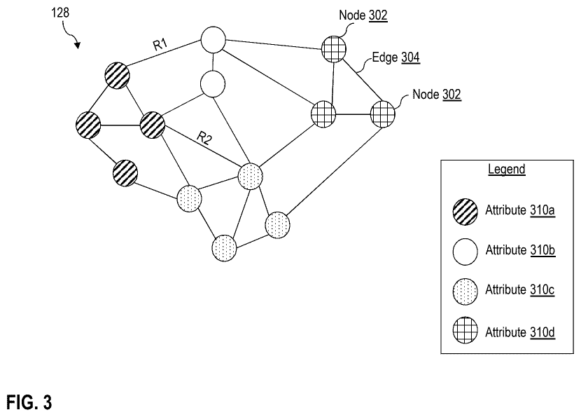

According to embodiments of the present disclosure, the data analysis application 124 may analyze the live language data associated with the particular subscriber device, the live numeric data associated with the particular subscriber device, historical language data 108 generated from customer care calls associated with a first group of subscriber devices retrieved from the customer care call interaction database 106, historical numeric data 104 associated with communications of a second group of subscriber devices retrieved from the customer care call interaction database 106, using graph modeling, to identify a candidate cause for the communication issue. As will be discussed more fully below with reference to FIGS. 2-3, the data analysis application 124 may use graph database generation model(s) 126 to generate a graph database 128 in runtime from the live language data, the live numeric data, the historical language data 108, and the historical numeric data 104. The data analysis application 124 may generate a visual representation of the graph database 128 and output the visual representation of the graph database 128 via a UI 122 of the data analysis system 120. The visual representation of the graph database 128 may provide insights into correlation (e.g., a data pattern) among the live language data, the live numeric data, the historical language data 108, and the historical numeric data 104. In an embodiment, a customer care agent 130 (answering the customer care call) may utilize insights gained from the correlation shown in the graph database 128 to assist the subscriber 140 in troubleshooting the communication issue. In some embodiments, at the end of the customer care call, the data capturing application 125 may store the live language data and the live numeric data respectively in the customer care call interaction database 106 and the customer device and network data database 102.

FIG. 1 is merely an example of components of a network system 100, and variations are contemplated to be within the scope of the present disclosure. In embodiments, the network system 100 may include other components not illustrated in FIG. 1. In embodiments, the network system 100 may not include every component illustrated in FIG. 1. In embodiments, the components and connections may be implemented with different connections than those illustrated in FIG. 1. For instance, while FIG. 1 illustrates the data analysis application 124 and the data capturing application 125 implemented in the same data analysis system 120, the data capturing application 125 may be implemented in another computer system. Such and other embodiments are contemplated to be within the scope of the present disclosure.

Turning now to FIG. 2, a method 200 for analyzing subscriber device communication issues based on a combination of customer device and network numeric data and customer care call language data using graph modeling is described. The method 200 illustrates operations performed by various components of the network system 100. Specifically, the components include the data analysis application 124, the data capturing application 125, the customer device and network data database 102, and the customer care call interaction database 106. However, it is contemplated that other component(s) of the network system 100 may be involved in performing the operations of the method 200. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

At operation 202, the data capturing application 125 may detect an incoming customer care call from a subscriber 140 reporting a technical communication issue (e.g., drop calls, poor audio quality, slow Internet connection, etc.) experienced by a particular subscriber device (e.g., a UE 142) of the subscriber 140. At operation 204, the data capturing application 125 may record the audio call based on an agreement from the subscriber 140. For instance, at the beginning of the customer care call, the subscriber 140 may be asked whether they consent to the recording of their call to the customer care. The recorded audio may include call interactions between the subscriber 140 and a customer care agent 130 who answered the call. In some instances, the customer care call may be received by an IVR system before the call reaches the customer care agent 130, and the recorded audio may also include interactions between the subscriber 140 and the IVR system.

At operation 206, the data capturing application 125 may apply speech-to-text conversion, tokenization, annotation, and vectorization to the recorded audio to generate live language data 230. For instance, the data capturing application 125 may apply speech-to-text conversion to the recorded audio to generate text data and apply tokenization, annotation, and vectorization to the text data to generate live language data 230. At operation 208, the data capturing application 125 may provide the generated live language data 230 to the data analysis application 124. The process of recording the audio call, generating the live language data 230, and providing the live language data 230 to the data analysis application 124 may be a continual process as the customer care call progresses. That is, the generation of the live language data 230 is in real time or near real time.

At operation 210, the data capturing application 125 may capture live numeric data 232 from the particular subscriber device based on an agreement of the subscriber 140. For instance, if the subscriber 140 consents to capture numeric data from the particular subscriber device, an OTA flag may be set (e.g., to a value of 1) at the particular subscriber device. Thus, the data capturing application 125 may read the OTA flag from the particular subscriber device. If the OTA flag is set, the data capturing application 125 may proceed to capture live numeric data 232 from the particular subscriber device. In an example, the live numeric data 232 may include operational data and/or events associated with operations at a radio layer, a modem layer, an application layer, a signaling layer, and/or an OS layer of the particular subscriber device. In some instances, the live numeric data 232 may include performance metrics (e.g., RSSIs, RSRPs, RSRQs, SINRs, BERs, PERs, latencies, throughputs, audio packet qualities, etc.), serving cell information (e.g., cell ID, carrier frequency, carrier band configuration, etc.), location information (e.g., user locations, handover or mobility patterns, etc.), signaling data and/or events (e.g., a time series of SIP signaling events), call information, device UI information, network events, and/or any suitable numeric operational data. At operation 212, the data capturing application 125 may provide the captured live numeric data 232 to the data analysis application 124. The process of capturing live numeric data 232 from the particular subscriber device and providing the live numeric data 232 to the data analysis application 124 may be a continual process as the customer care call progresses. That is, the generation of the live numeric data 232 is in real time or near real time.

At operation 214, the data analysis application 124 may retrieve historical numeric data 104 from the customer device and network data database 102. The historical numeric data 104 is captured from communication sessions of respective ones of a first group of subscriber devices (e.g., similar to the UE 142). In some instances, the historical numeric data 104 may include at least one of device operational data (e.g., captured at respective subscriber devices and received by the data capturing application 125 or another system) or network operational data (e.g., captured by the network monitoring system 150 at the network side).

At operation 216, the data analysis application 124 may retrieve historical language data 108 from the customer care call interaction database 106. The historical language data 108 is captured from customer care calls associated with respective ones of a second group of subscriber devices (e.g., similar to the UE 142). In some instances, the first group of subscriber devices may be the same as the second group of subscriber devices. In other instances, the first group of subscriber devices may be different than the second group of subscriber devices.

At operation 218, the data analysis application 124 may select, based on the communication issue of the particular subscriber device, a first portion from the live language data 230, a second portion from the live numeric data 232, a third portion from the historical language data 108, and a fourth portion from the historical numeric data 104. Stated differently, the data analysis application 124 may select data portions that are relevant (or of high priority) to the communication issue. In some instances, the data analysis application 124 may use an ML model (e.g., a regression model, an ML SVM model) to select the relevant data portions. Since the live language data 230, the live numeric data 232, the historical language data 108, and the historical numeric data 104 may include a large amount of information, selecting relevant portions (e.g., with high priorities for the communication issue) can speed up the analysis and provide a more focused analysis for the communication issue of the particular subscriber device.

The live language data 230, the live numeric data 232, the historical language data 108, and the historical numeric data 104 may be stored in relational databases (e.g., tables with columns and rows). For instance, a numeric data relational database may store various measurements, metrics, and events in columns, and each row may correspond to a communication session (e.g., voice calls or data sessions) or a particular time within a communication session. In a similar way, a language data relational database may store words, sentences, annotations, etc. in columns, and each row may correspond to a customer care call or a portion of a customer care call. Thus, the selection of each of the first portion, the second portion, the third portion, and the fourth portion may include prioritizing the columns based on the communication issues and selecting one or more highest priority columns from respective ones of the relational databases. In other examples, the roles of columns and rows may be reversed. That is, instead of storing data fields in columns and calls or communication sessions in rows, calls or communication sessions may be stored in columns and data fields may be stored in rows. In such examples, the selection of each of the first portion, the second portion, the third portion, and the fourth portion may include prioritizing the rows based on the communication issues and selecting one or more highest priority rows from respective ones of the relational databases.

At operation 220, the data analysis application 124 may generate attributes based on the selected first portion of the live language data 230, the second portion of the live numeric data 232, the third portion of the historical language data 108, and the fourth portion of the historical numeric data 104. The attributes may be related to subscriber identification information (e.g., phone numbers), performance metrics, serving cell information, location information, signaling patterns, call information, device UI information, network events, etc. As an example, the data analysis application 124 may generate four attributes, A1-A4, each from a respective column (or row) of a respective relational database. Referring to the audio quality or call drop issue example above, the attribute A1 may correspond to audio packet quality, the attribute A2 may correspond to a SIP signaling pattern, the attribute A3 may correspond to handover events associated with receiving subscriber devices, and the attribute A4 may correspond to specific location and/or time of calls. At operation 222, after generating the attributes, the data analysis application 124 may generate a graph database 128 based on the attributes and corresponding selected data portions (the first portion from the live language data 230, the second portion from the live numeric data 232, the third portion from the historical language data 108, and the fourth portion from the historical numeric data 104). The graph database 128 may include nodes corresponding to the attributes and the nodes may be connected based on the corresponding selected data portions.

Turning now to FIG. 3, a visual representation of an example graph database 128 is described. As shown, the graph database 128 may include nodes 302 connected by edges 304. For ease of illustration, only two nodes are labelled with 302 and one edge is labelled with 304. The nodes 302 may correspond to the attributes (shown as 310). For ease of illustration, FIG. 3 only illustrates four attributes 310a, 310b, 310c, and 310d. However, a graph database 128 can include any suitable number of nodes 302 (e.g., hundreds, thousands, tens of thousands, millions or more). As shown, the graph database 128 may include a first subset of the nodes 302 corresponding to the attribute 310a, a second subset of the nodes corresponding to the attribute 310b, a third subset of the nodes corresponding to the attribute 310c, and a fourth subset of the nodes corresponding to the attribute 310d. The nodes 302 may be connected based on the relationships among respective data in the live language data 230, live numeric data 232, the historical language data 108, and the historical numeric data 104. In some examples, the connections or edges 304 between two nodes 302 may be associated with certain labels to indicate a level of correlation between the two nodes 302 (or more specifically, the associated attributes 310). For ease of illustration, FIG. 3 only shows two labels R1 and R2 for respective edges 304. For instance, the label R1 may indicate a low correlation (e.g., between respective nodes 302 associated with attributes 310a and 310b), and the label R2 may indicate a strong correlation (e.g., between respective nodes 302 associated with attributes 310a and 310c).

Referring to the audio quality or call drop issue example above, the attribute 310a may correspond to audio packet quality, the attribute 310b may correspond to a SIP signaling pattern, the attribute 310c may correspond to handover events associated with receiving subscriber devices, and the attribute 310d may correspond to specific locations or timings of respective receiving subscriber devices. That is, each of the nodes 302 corresponding to the attribute 310a may have an associated audio packet quality indicator, each of the nodes 302 corresponding to the attribute 310b may have an associated SIP signaling pattern, each of the nodes 302 corresponding to the attribute 310c may have an associated receiving subscriber device handover event, and each of the nodes 302 corresponding to the attribute 310d may have an associated location of a respective receiving subscriber device.

As discussed above, the live language data 230, the live numeric data 232, the historical language data 108, and the historical numeric data 104 are stored in relational databases. As an example, the first data portion may include column W of the live language data 230, the second data portion may include column X of the live numeric data 232, the third data portion may include column Y of the historical language data 108, and the fourth data portion may include column Z of the historical numeric data 104. A set of connected nodes 302 may include a first node 302 corresponding to attribute 310a, a second node 302 corresponding to attribute 310b, a third node 302 corresponding to attribute 310c, and a fourth node 302 corresponding to attribute 310d, where the first, second, third, and fourth nodes 302 may respectively include first data in column W and row R1 of the live language data 230, second data in column X and row R2 of the live numeric data 232, third data in column Y and row R3 of the historical language data 108, and fourth data in column Z and row R4 of the historical numeric data 104.

Returning to FIG. 2, at operation 226, after generating the graph database 128, the data analysis application 124 may output a visual representation of the graph database 128 (e.g., via the UI 122). In an embodiment, the customer care agent 130 (answering the live customer care call) may utilize insights gained from the correlation (e.g., based on the labels R1 and R2 indicative of a level of correlation) shown in the graph database 128 to assist the subscriber 140 in troubleshooting the communication issue of the particular subscriber device. At operation 228, the data analysis application 124 may initiate various actions based on the graph database 128. For instance, the data analysis application 124 may identify a correlation among the nodes 302 (based on connections) shown in the graph database 128 and may identify a candidate cause for the communication issue based on the correlation. For instance, the data analysis application 124 may automatically initiate, based on the identified candidate cause, an installation of a software patch (e.g., for security updates, bug fixes, feature updates, software upgrades, etc.) to the particular subscriber device or a configuration update (e.g., a network setting, a preferred roaming list, a device profile, etc.) at the particular subscriber device, or reboot the particular subscriber device over the air.

In some instances, at operation 224, the data analysis application 124 may optionally perform dynamic update of the graph database 128. The dynamic update may include repeating operations 218, 220, and 222. The dynamic update may be based on a target objective or human feedback and may iterate through one or more iterations. In an example, the target objective may be based on a proximal policy optimization (PPO) algorithm. For the audio quality issue example, the target objective may be associated with RF values (e.g., RSRPs, RSRQs, SINRs, etc.) or QoS (e.g., MOS score). In some examples, the PPO may be associated with SIP messages and associated with RF values or attributes. In an example, the feedback may be human feedback (e.g., from a customer care agent) based on a failure to identify a correlation or relation among the nodes 302 in an initial graph database 128 or a new insight observed from the initial graph database. As part of the dynamic update, the data analysis application 124 may reselect, based on the target objective and/or the feedback, a fifth portion from the live language data 230, a sixth portion from the live numeric data 232, a seventh portion from the historical language data 108, and an eighth portion from the historical numeric data 104. Generally, one or more of the fifth, sixth, seventh, and eighth data portions (reselected during a current iteration) may be different than the respective first, second, third, and fourth data portions (selected in a previous iteration).

The data analysis application 124 may determine second attributes 310 based on the reselected fifth, sixth, seventh, and eighth data portions. The data analysis application 124 may generate a second graph database 128 based on the second attributes 310. The second graph database 128 may include nodes 302 corresponding to the second attributes 310, and the nodes 302 may be connected by connections based on relationships among respective data (in the fifth, sixth, seventh, and eighth data portions). As an example, the initial attributes 310 for generating the initial graph database 128 may be A1-A4, and the second attributes 310 for generating the second graph database 128 may be A1-A3. As another example, the initial attributes 310 for generating the initial graph database 128 may be A1-A4, and the second attributes 310 for generating the second graph database 128 may be A1-A3 and A5. Generally, the second attributes 310 may include at least one different attribute 310 than the initial attributes 310 and/or exclude at least one of the initial attributes 310. The operation 218 to 224 may be repeated as shown by the dashed arrow. The dynamic update may be terminated when the target objective is satisfied or no more feedback is received.

In an embodiment, the data analysis application 124 may utilize one or more graph database generation models 126 to perform the operations 218 to 224. In some instances, the one or more graph database generation models 126 may be an ML model or a regress model (e.g., a K-nearest neighbor (KNN) model, a cross-validation model, or an SVM model). In some instances, the one or more graph database generation models 126 may be a dimensional model (e.g., a medallion model). A medallion model may include a bronze layer, a silver layer, and a gold layer representing different stages of data refinement, with each layer progressively transforming raw data into highly refined, analytics-ready datasets. For instance, the bronze layer may include the live language data 230, the live numeric data 232, the historical language data 108, and the historical numeric data 104. The silver layer may include selecting data portions from the live language data 230, the live numeric data 232, the historical language data 108, and the historical numeric data 104 (e.g., operation 218) and generating attributes 310 from the selected data portions (e.g., operation 220). The gold layer may include generating a graph database 128 based on the selected data portions and generated attributes 310 (e.g., operation 222).

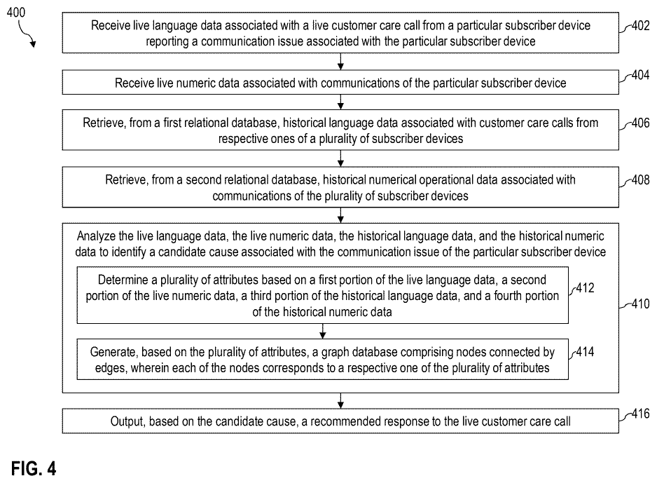

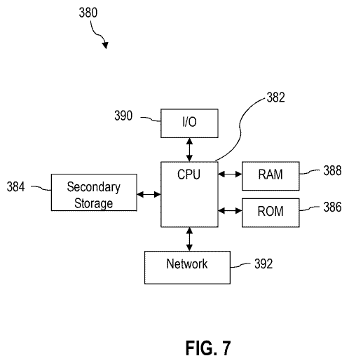

Turning now to FIG. 4, a method 400 is described. In an embodiment, the method 400 is a method of analyzing subscriber device communication issues based on a joint analysis of customer device and network numeric data and customer care call language data using graph data modeling in a network system 100. The method 400 may be implemented by a data analysis application 124. The method 400 may include similar mechanisms as discussed above with reference to FIGS. 1-3. In embodiments, the method 400 may be implemented using a computer system with components as shown in FIG. 7. As illustrated, FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At block 402, the data analysis application 124 receives live language data 230 associated with a live customer care call from a particular subscriber device (e.g., a UE 142) reporting a communication issue (e.g., a technical issue, such as a dropped call, low audio quality, failure to send text messages, slow Internet connection, etc.) associated with the particular subscriber device. For instance, the live language data 230 is generated based on an application of at least one of a speech-to-text conversion process, a tokenization process, an annotation process, or a vectorization process to audio data associated with the live customer care call originated from the particular subscriber device as discussed above with reference to operations 204 and 206 of FIG. 2. The live language data 230 includes at least one of communication issue information associated with at least one of an incoming call, an outgoing call, text messages, data download, or data upload, or sentiment information (e.g., opinions or emotions of the subscriber 140 that made the live customer care call).

At block 404, the data analysis application 124 receives live numeric data 232 associated with communications of the particular subscriber device. In some instances, the live numeric data 232 and the historical numeric data 104, each includes operational data associated with at least one of a radio interface layer, a modem layer, an application layer, a signaling layer, or an OS layer. In some instances, the live numeric data 232 and the historical numeric data 104, each may include network performance metrics (e.g., RSSIs, RSRPs, RSRQs, SINRs, latencies, bandwidth utilizations, BERs, PERs, throughput, etc.), cell information (e.g., cell ID, carrier frequencies, carrier band configurations, etc.), location information (e.g., altitude, latitude coordinate information of users or subscribers, handover or mobility patterns, etc.), signaling data and/or events (e.g., a time series of SIP signaling events), call information, device UI information, and/or network events associated with communications of a respective subscriber device. In some instances, the historical numeric data 104 may include at least one of device operational data (e.g., captured at respective subscriber devices) or network device operational data (e.g., captured by the network monitoring system 150 at the network side).

At block 406, the data analysis application 124 retrieves, from a first relational database (e.g., the customer care call interaction database 106), historical language data 108 associated with customer care calls from respective ones of a first plurality of subscriber devices (e.g., UEs 142). At block 408, the data analysis application 124 retrieves, from a second relational database (e.g., the customer device and network data database 102), historical numerical data 104 associated with communications of a second plurality of subscriber devices (e.g., UEs 142). In some instances, the first plurality of subscriber devices associated with the historical language data 108 are the same as the second plurality of subscriber devices associated with the historical numeric data 104. In other instances, the first plurality of subscriber devices associated with the historical language data 108 are different than the second plurality of subscriber devices associated with the historical numeric data 104.

At block 410, the data analysis application 124 analyzes the live language data 230, the live numeric data 232, the historical language data 108, and the historical numeric data 104 to identify a candidate cause associated with the communication issue of the particular subscriber device. As part of the analyzing, the data analysis application 124 performs operations at blocks 412 and 414. At block 412, the data analysis application 124 determines a plurality of attributes 310 based on a first portion of the live language data 230, a second portion of the live numeric data 232, a third portion of the historical language data 108, and a fourth portion of the historical numeric data 104. In some instances, the plurality of attributes 310 are associated with at least one of subscriber identification information (e.g., phone numbers), performance metrics, serving cell information, location information, signaling information, call information, device UI information, or network events.

At block 414, the data analysis application 124 generates, based on the plurality of attributes 310, a graph database 128 comprising nodes 302 connected by edges 304. Each of the nodes 302 corresponds to a respective one of the plurality of attributes 310. The candidate cause is identified based on connections among a subset of the nodes 302 in the graph database 128. At block 416, the data analysis application 124 outputs, based on the candidate cause, a recommended response to the live customer call.

In embodiments, as part of the analyzing at block 410, the data analysis application 124 further selects, based at least in part on the reported communication issue of the particular subscriber device, the first portion from the live language data 230. The data analysis application 124 further selects, based at least in part on the reported communication issue, the second portion from the live numeric data 232. The data analysis application 124 further selects, based at least in part on the reported communication issue, the third portion from the historical language data 108. The data analysis application 124 further selects, based at least in part on the reported communication issue, the fourth portion from the historical numeric data 104. In embodiments, the live language data 230 is stored in a third relational database, the live numeric data 232 is stored in a fourth relational database, and each of the selected first, second, third, and fourth portions corresponds to one or more columns or one or more rows respectively in the third, fourth, first, and second relational databases. In embodiments, the data analysis application 124 further provides, via a UI 122, a visual representation of at least a portion of the graph database 128 and a visual indication of the candidate cause for the communication issue.

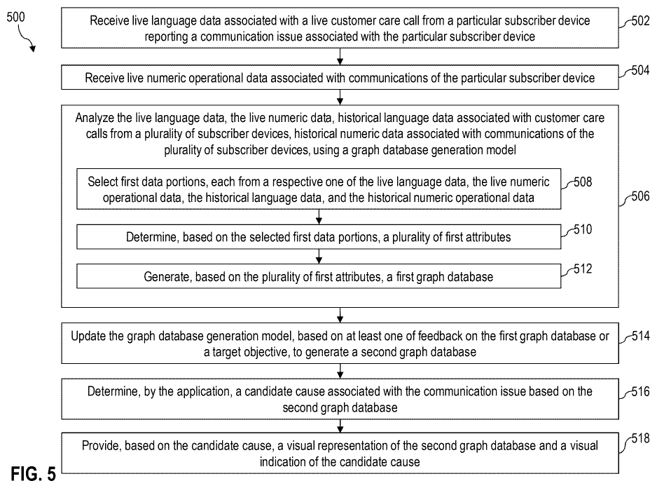

Turning now to FIG. 5, a method 500 is described. In an embodiment, the method 500 is a method of analyzing subscriber device communication issues using a graph database generation model 126 with dynamic update of the graph database generation model 126. The method 500 may be implemented by a data analysis application 124. The method 500 may include similar mechanisms as discussed above with reference to FIGS. 1-4. In embodiments, the method 500 may be implemented using a computer system with components as shown in FIG. 7. As illustrated, FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At block 502, the data analysis application 124 receives live language data 230 associated with a live customer care call from a particular subscriber device (e.g., a UE 142) reporting a communication issue (e.g., a technical issue, such as a dropped call, low audio quality, failure to send text messages, slow Internet connection, etc.) associated with the particular subscriber device. At block 504, the data analysis application 124 receives live numeric data 232 associated with communications of the particular subscriber device.

At block 506, the data analysis application 124 analyzes the live language data 230, the live numeric data 232, historical language data 108 associated with customer care calls from a first plurality of subscriber devices (e.g., UEs 142), historical numeric data 104 associated with communications of a second plurality of subscriber devices (e.g., UEs 142), using a graph database generation model 126. As part of the analysis, the data analysis application 124 performs operations at blocks 508-512. At block 508, the data analysis application 124 selects first data portions, each from a respective one of the live language data 230, the live numeric data 232, the historical language data 108, and the historical numeric data 104. At block 510, the data analysis application 124 determines, based on the selected first data portions, a plurality of first attributes 310. At block 512, the data analysis application 124 generates, based on the plurality of first attributes 310, a first graph database 128. At block 514, the data analysis application 124 updates the graph database generation model 126, based on at least one of feedback on the first graph database 128 or a target objective, to generate a second graph database 128. In embodiments, the target objective is based on a PPO algorithm.

At block 516, the data analysis application 124 determines a candidate cause associated with the communication issue based on the second graph database 128. At block 518, the data analysis application 124 provides, via a UI 122, a visual representation of the second graph database 128 and a visual indication of the candidate cause.

In embodiments, as part of updating the graph database generation model 126 at block 514, the data analysis application 124 selects second data portions, each from a respective one of the live language data 230, the live numeric data 232, the historical language data 108, and the historical numeric data 104, where the second data portions are different than the first data portions. Further, the data analysis application 124 determines, based on the selected second data portions, a plurality of second attributes 310 different than the plurality of first attributes 310. Further, the data analysis application 124 generates, based on the plurality of second attributes 310, the second graph database 128.

In embodiments, the data analysis application 124 further provides, via the UI 122, a visual representation of the first graph database 128. The data analysis application 124 further receives, via the UI 122, the feedback based on connections among at least a subset of nodes 302 in the first graph database 128. In embodiments, the graph database generation model 126 includes an ML model. In embodiments, the graph database generation model 126 is based on a dimensional data model (e.g., a medallion model).

Turning now to FIG. 6A, an exemplary communication system 550 is described. Typically the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a RAN in some contexts. In a 5G technology generation an access node 554 may be referred to as a next Generation Node B (gNB). In 4G technology (e.g., LTE technology) an access node 554 may be referred to as an evolved Node B (eNB). In 3G technology (e.g., CDMA and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as long term evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general Internet service providers for laptops and desktop computers, competing with existing ISPs such as cable Internet, and also will make possible new applications in internet of things (IoT) and machine to machine areas.

In accordance with the RAT, each access node 554 could provide service on one or more RF carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 6B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a SMF 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 7 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), IP, time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A computer-implemented method of analyzing subscriber device communication issues based on a joint analysis of customer device and network numeric data and customer care call language data using graph data modeling, the method comprising:
receiving, by an application at a computer system, live language data associated with a live customer care call from a particular subscriber device, wherein the live language data comprises an indication of a communication issue associated with the particular subscriber device;
receiving, by the application, live numeric data associated with communications of the particular subscriber device;
analyzing, by the application, the live language data, the live numeric data, historical language data associated with customer care calls from a first plurality of subscriber devices, and historical numeric data associated with communications of a second plurality of subscriber devices to identify a candidate cause associated with the communication issue of the particular subscriber device, wherein the analyzing comprises:
generating a graph database based on a data portion from each of the live language data, the live numeric data, the historical language data, and the historical numeric data, wherein the candidate cause is identified based on the graph database; and
initiating, by the application, based on the identified candidate cause, an action at the particular subscriber device.

2. The method of claim 1, wherein:
the generating the graph database comprises:
selecting, based on the communication issue, a first data portion, a second data portion, a third data portion, and a fourth data portion respectively from the live language data, the live numeric data, the historical language data, and the historical numeric data; and
determining a plurality of attributes based on the first, second, third, and fourth data portions, and
the graph database comprises nodes, each corresponding to a respective one of the plurality of attributes.

3. The method of claim 1, wherein the initiating the action at the particular subscriber device comprises:
initiating, by the application, at least one of a software update, a configuration update, or a reboot at the particular subscriber device.

4. The method of claim 1, wherein the live language data is based on an application of at least one of a tokenization process, an annotation process, or a vectorization process to audio data associated with the live customer care call originated from the particular subscriber device.

5. The method of claim 1, wherein the live numeric data and the historical numeric data, each comprises at least one of performance metrics, cell information, location information, signaling information, call information, device user interface information, or network events.

6. A computer-implemented method of analyzing subscriber device communication issues, the method comprising:
receiving, by an application at a computer system, live language data associated with a live customer care call from a particular subscriber device, wherein the live language data is indicative of a communication issue associated with the particular subscriber device;
receiving, by the application, live numeric data associated with communications of the particular subscriber device;
analyzing, by the application, the live language data, the live numeric data, historical language data associated with customer care calls from a first plurality of subscriber devices, and historical numeric data associated with communications of a second plurality of subscriber devices, using a graph database generation model, wherein the analyzing comprises:
selecting first data portions, each from a respective one of the live language data, the live numeric data, the historical language data, and the historical numeric data;
determining, based on the selected first data portions, a plurality of first attributes;
generating, based on the plurality of first attributes, a first graph database;
updating the graph database generation model, based on at least one of feedback on the first graph database or a target objective, to generate a second graph database;
determining, by the application, a candidate cause associated with the communication issue based on the second graph database;
providing, by the application, via a user interface (UI), a visual representation of the second graph database and a visual indication of the candidate cause; and
initiating, by the application, based on the determined candidate cause, an action at the particular subscriber device.

7. The method of claim 6, wherein the updating the graph database generation model comprises:
selecting, by the application, second data portions, each from a respective one of the live language data, the live numeric data, the historical language data, and the historical numeric data, wherein the second data portions are different than the first data portions;
determining, by the application, based on the selected second data portions, a plurality of second attributes; and
generating, by the application, based on the plurality of second attributes, the second graph database.

8. The method of claim 6, wherein the target objective is based on a proximal policy optimization algorithm.

9. The method of claim 6, further comprising:
providing, by the application via the UI, a visual representation of the first graph database; and
receiving, by the application, via the UI, the feedback based on the first graph database.

10. The method of claim 6, wherein the graph database generation model comprises a machine learning (ML) model.

11. The method of claim 6, wherein the graph database generation model is based on a dimensional data model.

12. A method comprising:
receiving, by an application at a computer system, live language data associated with a live customer care call from a particular subscriber device reporting a communication issue associated with the particular subscriber device;
receiving, by the application, live numeric data associated with communications of the particular subscriber device;
retrieving, by the application, from a first relational database, historical language data associated with customer care calls from respective ones of a first plurality of subscriber devices;
retrieving, by the application, from a second relational database, historical numeric data associated with communications of a second plurality of subscriber devices;
analyzing, by the application, the live language data, the live numeric data, the historical language data, and the historical numeric data to identify a candidate cause associated with the communication issue of the particular subscriber device, wherein the analyzing comprises:
determining a plurality of attributes based on a first portion of the live language data, a second portion of the live numeric data, a third portion of the historical language data, and a fourth portion of the historical numeric data; and
generating, based on the plurality of attributes, a graph database comprising nodes connected by edges, wherein each of the nodes corresponds to a respective one of the plurality of attributes, and wherein the candidate cause is identified based on connections among a subset of the nodes in the graph database;
outputting, by the application, based on the candidate cause, a recommended response to the live customer care call; and
initiating, by the application, based on the identified candidate cause, an action at the particular subscriber device.

13. The method of claim 12, wherein the live language data is based on an application of at least one of a tokenization process, an annotation process, or a vectorization process to audio data associated with the live customer care call originated from the particular subscriber device.

14. The method of claim 12, wherein the live language data comprises at least one of:
communication issue information associated with at least one of an incoming call, an outgoing call, text messages, data download, or data upload, or
sentiment information.

15. The method of claim 12, wherein the live numeric data and the historical numeric data, each comprises operational data associated with at least one of:
a radio interface layer,
a modem layer,
an application layer,
a signaling layer, or
an operating system layer.

16. The method of claim 12, wherein the plurality of attributes is associated with at least one of:
performance metrics,
location information,
cell information,
signaling information,
call information,
device user interface information, or
network events.

17. The method of claim 12, wherein:
the live language data is stored in a third relational database,
the live numeric data is stored in a fourth relational database, and each of the live language data, the live numeric data, the historical language data, the historical numeric data are stored in one or more relational databases, and
each of the first portion, the second portion, the third portion, and the fourth portion correspond to one or more columns or one or more rows respectively in the third, fourth, first, and second relational databases.

18. The method of claim 12, wherein the analyzing further comprises:
selecting, based at least in part on the reported communication issue of the particular subscriber device, the first portion from the live language data;
selecting, based at least in part on the reported communication issue, the second portion from the live numeric data;
selecting, based at least in part on the reported communication issue, the third portion from the historical language data; and
selecting, based at least in part on the reported communication issue, the fourth portion from the historical numeric data.

19. The method of claim 12, further comprising:
providing, by the application, via a user interface of the computer system, a visual representation of at least a portion of the graph database and a visual indication of the candidate cause for the communication issue.

20. The method of claim 12, wherein the historical numeric data associated with the communications of the second plurality of subscriber devices comprises at least one of numeric device operational data or numeric network operational data.
